(19) United States
(12) Patent Application Publication
(10) Pub. No.: US 2024/0212890 A1
(43) Pub. Date: Jun. 27, 2024

(54) CHIP RESISTOR

(71) Applicant: ROHM CO., LTD., Kyoto-shi (JP)

(72) Inventor: Takanori SHINOURA, Kyoto-shi (JP)

(21) Appl. No.: 18/594,657

(22) Filed: Mar. 4, 2024

Related U.S. Application Data
(63) Continuation of application No. PCT/JP22/24172, filed on Jun. 16, 2022.

(30) Foreign Application Priority Data
Sep. 30, 2021 (JP) 2021-160318

(51) Int. Cl. H01C 7/00; H01C 1/08; H01C 1/14

(52) U.S. Cl. CPC H01C 7/003; H01C 1/08; H01C 1/14

(57) ABSTRACT

A chip resistor includes an insulating substrate, a first electrode, a second electrode, a resistor, a first heat transfer layer, a second heat transfer layer, and an insulating protective layer. The first heat transfer layer has a thermal conductivity greater than that of the insulating protective layer, and is in contact with the resistor and a first front electrode. The second heat transfer layer is separated from the first heat transfer layer. The second heat transfer layer has a thermal conductivity greater than that of the insulating protective layer, and is in contact with the resistor and a second front electrode.

### TECHNICAL FIELD

The present disclosure relates to a chip resistor.

### BACKGROUND ART

Japanese Patent Laying-Open No. 2008-277638 (PTL 1) discloses a chip resistor that includes an insulating substrate, an upper electrode, a lower electrode, an end electrode, a resistor, an insulating protective film, and a surface coating film.

### Citation List

### Patent Literature

PTL 1: Japanese Patent Laying-Open No. 2008-277638

### [SUMMARY]

In the chip resistor of PTL 1, the entire resistor is covered with an insulating protective film. Therefore, the temperature in a central portion of the chip resistor rises excessively during the use of the chip resistor, which makes the short-time overload (STOL) characteristics of the chip resistor insufficient. The present disclosure has been made to solve the aforementioned problems, and an object of the present disclosure to improve the short-time overload (STOL) characteristics of a chip resistor.

The chip resistor of the present disclosure includes an insulating substrate, a first electrode, a second electrode, a resistor, a first heat transfer layer, a second heat transfer layer, and an insulating protective layer. The insulating substrate includes a first main surface, a first side surface, and a second side surface opposite to the first side surface. The first side surface and the second side surface are each connected to the first main surface. The resistor is provided on the first main surface of the insulating substrate. The first electrode is provided on a side of the first side surface of the insulating substrate. The first electrode includes a first front electrode provided on a first main surface of the insulating substrate. The second electrode is provided on a side of the second side surface of the insulating substrate, and is separated from the first electrode. The second electrode includes a second front electrode provided on the first main surface of the insulating substrate and separated from the first front electrode. The resistor is in contact with the first front electrode and the second front electrode. The first heat transfer layer has a thermal conductivity greater than that of the insulating protective layer, and is in contact with the resistor and the first front electrode. The second heat transfer layer is separated from the first heat transfer layer. The second heat transfer layer has a thermal conductivity greater than that of the insulating protective layer, and is in contact with the resistor and the second front electrode. The insulating protective layer is provided on the resistor. The insulating protective layer electrically insulates the first electrode and the second electrode from each other, and electrically insulates the first heat transfer layer and the second heat transfer layer from each other.

### BRIEF DESCRIPTION OF DRAWINGS

FIG. 1 is a schematic plan view illustrating a chip resistor according to an embodiment;

FIG. 2 is a schematic cross-sectional view illustrating the chip resistor taken along a cross-sectional line II-II in FIG. 1 according to an embodiment;

FIG. 3 is a schematic cross-sectional view illustrating a chip resistor mounted on a wiring substrate according to an embodiment;

FIG. 4 is a schematic cross-sectional view illustrating a step of a method of manufacturing a chip resistor according to an embodiment;

FIG. 5 is a schematic cross-sectional view illustrating a step subsequent to the step illustrated in FIG. 4 in the method of manufacturing the chip resistor according to the embodiment;

FIG. 6 is a schematic cross-sectional view illustrating a step subsequent to the step illustrated in FIG. 5 in the method of manufacturing the chip resistor according to the embodiment;

FIG. 7 is a schematic cross-sectional view illustrating a step subsequent to the step illustrated in FIG. 6 in the method of manufacturing the chip resistor according to the embodiment;

FIG. 8 is a schematic cross-sectional view illustrating a step subsequent to the step illustrated in FIG. 7 in the method of manufacturing the chip resistor according to the embodiment;

FIG. 9 is a schematic cross-sectional view illustrating a step subsequent to the step illustrated in FIG. 8 in the method of manufacturing the chip resistor according to the embodiment;

FIG. 10 is a schematic cross-sectional view illustrating a chip resistor according to a first modification; and

FIG. 11 is a schematic cross-sectional view illustrating a chip resistor according to a second modification.

### [DETAILED DESCRIPTION]

Next, an embodiment of the present disclosure will be described in detail with reference to the drawings. In the following drawings, the same or equivalent portions are denoted by the same reference numerals, and the description thereof will not be repeated. At least some features in the embodiment to be described below may be arbitrarily combined.

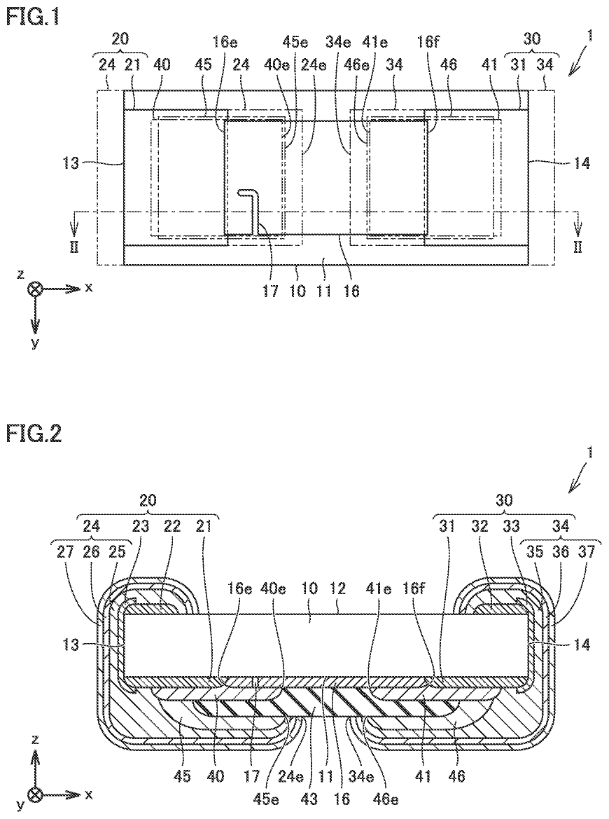

With reference to FIGS. 1 and 2, a chip resistor 1 according to an embodiment will be described. The chip resistor 1 mainly includes an insulating substrate 10, a first electrode 20, a second electrode 30, a resistor 16, a first heat transfer layer 40, a second heat transfer layer 41, and an insulating protective layer 43. The chip resistor 1 May further include a first conductive resin layer 45 and a second conductive resin layer 46. In FIG. 1, the insulating protective layer 43 is omitted for the convenience of illustration.

The insulating substrate 10 is an electric insulator made of an electrical insulating material such as alumina (Al₂O₃). The insulating substrate 10 includes a first main surface 11, a second main surface 12 opposite to the first main surface 11, a first side surface 13, and a second side surface 14 opposite to the first side surface 13. The first side surface 13 and the second side surface 14 are each connected to the first main surface 11 and the second main surface 12. Each of the first main surface 11 and the second main surface 12 extends along a first direction (x direction) and a second direction (y direction) perpendicular to the first direction. The first direction (x direction) is, for example, a longitudinal direction of the insulating substrate 10. The first electrode 20 and the second electrode 30 are separated from each other in the first direction (x direction). The first side surface 13 and the second side surface 14 are separated from each other in the first direction (x direction). The second direction (y direction) is, for example, a short direction of the insulating substrate 10. The first main surface 11 and the second main surface 12 are separated from each other in a third direction (z direction) perpendicular to both the first direction (x direction) and the second direction (y direction). The third direction (z direction) is a thickness direction of the insulating substrate 10.

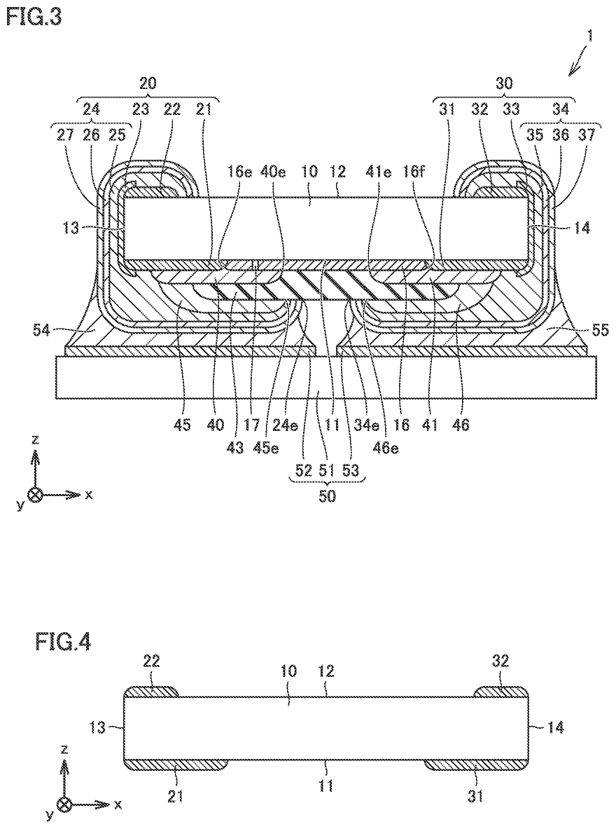

With reference to FIG. 3, when the chip resistor 1 is mounted on a wiring substrate 50 (see FIG. 3), the first main surface 11 faces the wiring substrate 50. In other words, the first main surface 11 is a mounting surface for mounting the chip resistor 1 on the wiring substrate 50. The first main surface 11 is a mounting surface on which the resistor 16 is mounted.

The resistor 16 functions to limit a current or detect a current. The resistor 16 is provided on the first main surface 11 of the insulating substrate 10. The resistor 16 includes an end 16e and an end 16f opposite to the end 16e. The end 16e is a proximal end of the resistor 16 relative to the first side surface 13. The end 16e is in contact with a first front electrode 21. The end 16f is a proximal end of the resistor 16 relative to the second side surface 14. The end 16f is in contact with a second front electrode 31. The resistor 16 is formed, for example, by printing a paste which is obtained by adding fritted glass to an electrical resistance material such as ruthenium oxide (RuO₂) or a silver-palladium alloy on the first main surface 11 of the insulating substrate 10 and firing the paste.

The resistor 16 is provided with a trimming groove 17. It is possible to accurately determine the resistance value of the chip resistor 1 (the resistor 16) by forming a trimming groove 17 on the resistor 16. In a plan view of the first main surface 11 of the insulating substrate 10, the trimming groove 17 has, for example, an

L-shape extending in the first direction (x direction) and the second direction (y direction). The trimming groove 17 May have an I-shape extending in the second direction (y direction).

The first electrode 20 is provided on a side of the first side surface 13 of the insulating substrate 10. The first electrode 20 is closer to the first side surface 13 than the second side surface 14. The first electrode 20 includes a first front electrode 21. The first electrode 20 May further include a first back electrode 22, a first side electrode 23, and a first metal plating layer 24.

The first front electrode 21 is provided on the first main surface 11 of the insulating substrate 10. The first front electrode 21 is in contact with the resistor 16.

The first front electrode 21 is closer to the first side surface 13 than the resistor 16. The first front electrode 21 is formed, for example, by printing a paste containing silver on the first main surface 11 of the insulating substrate 10 and firing the paste.

The first back electrode 22 is provided on the second main surface 12 of the insulating substrate 10. In a plan view of the first main surface 11 of the insulating substrate 10, the first back electrode 22 overlaps with the first front electrode 21. The first back electrode 22 is formed, for example, by printing a paste containing silver on the second main surface 12 of the insulating substrate 10 and firing the paste.

The first side electrode 23 is provided on the first side surface 13 of the insulating substrate 10, the first front electrode 21 and the first back electrode 22. The first side electrode 23 covers the first side surface 13 of the insulating substrate 10, the first front electrode 21 and the first back electrode 22. The first side electrode 23 includes a first portion formed on the first side surface 13 of the insulating substrate 10, a second portion overlapping with the first main surface 11 of the insulating substrate 10 in a plan view from the thickness direction (z direction) of the insulating substrate 10, and a third portion overlapping with the second main surface 12 of the insulating substrate 10 in a plan view from the thickness direction (z direction) of the insulating substrate 10. The first side electrode 23 is electrically connected to the first front electrode 21 and the first back electrode 22. The resistor 16 is electrically connected to the first back electrode 22 through the first front electrode 21 and the first side electrode 23. The first side electrode 23 May be made of a conductive material which is difficult to be sulfurized. The first side electrode 23 is made of, for example, a Ni—Cr alloy.

The first metal plating layer 24 is provided on the first front electrode 21, the first back electrode 22, the first side electrode 23, the first heat transfer layer 40, and the first conductive resin layer 45. The first metal plating layer 24 is in contact with the first front electrode 21, the first back electrode 22, the first side electrode 23, the first heat transfer layer 40, and the first conductive resin layer 45. In a plan view of the first main surface 11 of the insulating substrate 10, an end 24e of the first metal plating layer 24 is a distal end of the first metal plating layer 24 relative to the first side surface 13 of the insulating substrate 10. The first metal plating layer 24 includes, for example, a first inner plating layer 25, a first intermediate plating layer 26, and a first outer plating layer 27.

The first inner plating layer 25 is formed on the first front electrode 21, the first back electrode 22, the first side electrode 23, the first heat transfer layer 40, and the first conductive resin layer 45. The first inner plating layer 25 is, for example, a copper plating layer.

The first intermediate plating layer 26 is formed on the first inner plating layer 25, and covers the first inner plating layer 25. The first intermediate plating layer 26 protects the first front electrode 21, the first back electrode 22, the first side electrode 23, and the first inner plating layer 25 from heat and impact. The first intermediate plating layer 26 is, for example, a nickel plating layer.

The first outer plating layer 27 is formed on the first intermediate plating layer 26, and covers the first intermediate plating layer 26. The first outer plating layer 27 is made of a material to which a conductive bonding member 54 (see FIG. 3) such as solder is more likely to adhere than the first intermediate plating layer 26. The first outer plating layer 27 is, for example, a tin plating layer. The conductive bonding member 54 bonds the first outer plating layer 27 to the electrical wiring 52 of the wiring substrate 50 (see FIG. 3) so as to mount the chip resistor 1 on the wiring substrate 50.

The second electrode 30 is provided on a side of the second side surface 14 of the insulating substrate 10. The second electrode 30 is closer to the second side surface 14 than the first side surface 13. The second electrode 30 is separated from the first electrode 20 in the first direction (x direction). The second electrode 30 includes a second front electrode 31. The second electrode 30 May further include a second back electrode 32, a second side electrode 33, and a second metal plating layer 34.

The second front electrode 31 is provided on the first main surface 11 of the insulating substrate 10. The second front electrode 31 is separated from the first front electrode 21 in the first direction (x direction). The second front electrode 31 is in contact with the resistor 16. The second front electrode 31 is closer to the second side surface 14 than the resistor 16. The second front electrode 31 is formed, for example, by printing a paste containing silver on the first main surface 11 of the insulating substrate 10 and firing the paste.

The second back electrode 32 is provided on the second main surface 12 of the insulating substrate 10. The second back electrode 32 is separated from the first back electrode 22 in the first direction (x direction). In a plan view of the first main surface 11 of the insulating substrate 10, the second back electrode 32 overlaps with the second front electrode 31. The second back electrode 32 is formed, for example, by printing a paste containing silver on the second main surface 12 of the insulating substrate 10 and firing the paste.

The second side electrode 33 is provided on the second side surface 14 of the insulating substrate 10, the second front electrode 31, and the second back electrode 32. The second side electrode 33 covers the second side surface 14 of the insulating substrate 10, the second front electrode 31, and the second back electrode 32. The second side electrode 33 includes a first portion formed on the second side surface 14 of the insulating substrate 10, a second portion overlapping with the first main surface 11 of the insulating substrate 10 in a plan view from the thickness direction (z direction) of the insulating substrate 10, and a third portion overlapping with the second main surface 12 of the insulating substrate 10 in a plan view from the thickness direction (z direction) of the insulating substrate 10. The second side electrode 33 is electrically connected to the second front electrode 31 and the second back electrode 32. The resistor 16 is electrically connected to the second back electrode 32 through the second front electrode 31 and the second side electrode 33. The second side electrode 33 May be made of a conductive material which is difficult to be sulfurized. The second side electrode 33 is made of, for example, a Ni-Cr alloy.

The second metal plating layer 34 is provided on the second front electrode 31, the second back electrode 32, the second side electrode 33, the second heat transfer layer 41, and the second conductive resin layer 46. The second metal plating layer 34 is in contact with the second front electrode 31, the second back electrode 32, the second side electrode 33, the second heat transfer layer 41, and the second conductive resin layer 46. In a plan view of the first main surface 11 of the insulating substrate 10, an end 34e of the second metal plating layer 34 is a distal end of the second metal plating layer 34 relative to the second side surface 14 of the insulating substrate 10. The second metal plating layer 34 includes, for example, a second inner plating layer 35, a second intermediate plating layer 36, and a second outer plating layer 37.

The second inner plating layer 35 is provided on the second front electrode 31, the second back electrode 32, the second side electrode 33, the second heat transfer layer 41, and the second conductive resin layer 46. The second inner plating layer 35 is, for example, a copper plating layer.

The second intermediate plating layer 36 is provided on the second inner plating layer 35, and covers the second inner plating layer 35. The second intermediate plating layer 36 protects the second front electrode 31, the second back electrode 32, the second side electrode 33, and the second inner plating layer 35 from heat and impact. The second intermediate plating layer 36 is, for example, a nickel plating layer.

The second outer plating layer 37 is provided on the second intermediate plating layer 36, and covers the second intermediate plating layer 36. The second outer plating layer 37 is made of a material to which the conductive bonding member 55 (see FIG. 3) such as solder is more likely to adhere than the second intermediate plating layer 36. The second outer plating layer 37 is, for example, a tin plating layer. The conductive bonding member 55 bonds the second outer plating layer 37 to the electrical wiring 53 of the wiring substrate 50 (see FIG. 3) so as to mount the chip resistor 1 on the wiring substrate 50.

The first heat transfer layer 40 has a thermal conductivity greater than that of the insulating protective layer 43. The first heat transfer layer 40 has a thermal conductivity of, for example, 1.0 W/(m·K) or more. The first heat transfer layer 40 may have a thermal conductivity of 3.0 W/(m·K) or more, and may have a thermal conductivity of 5.0 W/(m·K) or more. The first heat transfer layer 40 is in contact with the resistor 16, the first front electrode 21 and the first conductive resin layer 45. The first heat transfer layer 40 May be further in contact with the first metal plating layer 24 (the first inner plating layer 25). The first heat transfer layer 40 includes an end 40e that is a distal end of the first heat transfer layer 40 relative to the first side surface 13 of the insulating substrate 10 in a plan view of the first main surface 11 of the insulating substrate 10.

In a plan view of the first main surface 11 of the insulating substrate 10, the first heat transfer layer 40 covers, for example, 20% or more of the total area of the resistor 16. In a plan view of the first main surface 11 of the insulating substrate 10, the first heat transfer layer 40 May cover 25% or more of the total area of the resistor 16, 30% or more of the total area of the resistor 16, 35% or more of the total area of the resistor 16, or 40% or more of the total area of the resistor 16. In a plan view of the first main surface 11 of the insulating substrate 10, the first heat transfer layer 40 covers, for example, less than 50% of the total area of the resistor 16.

In a plan view of the first main surface 11 of the insulating substrate 10, the first heat transfer layer 40 covers at least a part of the trimming groove 17. In a plan view of the first main surface 11 of the insulating substrate 10, the first heat transfer layer 40 may cover 50% or more of the total length of the trimming groove 17, 60% or more of the total length of the trimming groove 17, 70% or more of the total length of the trimming groove 17, 80% or more of the total length of the trimming groove 17, 90% or more of the total length of the trimming groove 17, or the entire trimming groove 17.

The first heat transfer layer 40 includes a binder resin and thermally conductive particles added to the binder resin. The binder resin is formed of an epoxy resin, a phenolic resin, or a combination thereof. The thermally conductive particles have a thermal conductivity greater than that of the binder resin. The thermally conductive particles are made of, for example, a material having a thermal conductivity of 5.0 W/(m·K) or more. The thermally conductive particles may be made of a material having a thermal conductivity of 10.0 W/(m·K) or more, or may be made of a material having a thermal conductivity of 20.0 W/(m·K) or more. The thermally conductive particles are, for example, metal particles such as silver particles or copper particles, carbon particles, or a combination thereof. The first heat transfer layer 40 is formed, for example, by printing a paste containing a binder resin and thermally conductive particles and curing the paste.

The first heat transfer layer 40 May be electrically conductive. First electrical resistivity of the first heat transfer layer 40 is greater than electrical resistivity of the resistor 16. The first electrical resistivity of the first heat transfer layer 40 is, for example, 1000 times or more than the electrical resistivity of the resistor 16. The first electrical resistivity of the first heat transfer layer 40 is greater than the electrical resistivity of the first front electrode 21. The first electrical resistivity of the first heat transfer layer 40 is, for example, 10000 times or more than the electrical resistivity of the first front electrode 21.

The second heat transfer layer 41 has a thermal conductivity greater than that of the insulating protective layer 43. The second heat transfer layer 41 has a thermal conductivity of, for example, 1.0 W/(m·K) or more. The second heat transfer layer 41 may have a thermal conductivity of 3.0 W/(m·K) or more, and may have a thermal conductivity of 5.0 W/(m·K) or more. The second heat transfer layer 41 is in contact with the resistor 16, the second front electrode 31, and the second conductive resin layer 46. The second heat transfer layer 41 May be further in contact with the second metal plating layer 34 (the second inner plating layer 35). The second heat transfer layer 41 is separated from the first heat transfer layer 40 in the first direction (x direction). The second heat transfer layer 41 includes an end 41e which is a distal end of the second heat transfer layer 41 relative to the second side surface 14 of the insulating substrate 10 in a plan view of the first main surface 11 of the insulating substrate 10.

The shortest distance between the end 40e of the first heat transfer layer 40 and the end 41e of the second heat transfer layer 41 is, for example, 300 μm or more.

Therefore, even though the first heat transfer layer 40 and the second heat transfer layer 41 are electrically conductive, it is possible to reliably prevent the first heat transfer layer 40 and the second heat transfer layer 41 from being brought into contact with each other to electrically short-circuit the first heat transfer layer 40 and the second heat transfer layer 41 at the time of forming the first heat transfer layer 40 and the second heat transfer layer 41. In a plan view of the first main surface 11 of the insulating substrate 10, the first heat transfer layer 40 May cover a region of the resistor 16 that is 200 μm or less from the end 16e of the resistor 16. The distance between the end 40e of the first heat transfer layer 40 and the end 16e of the resistor 16 in the first direction (x direction) may be 200 μm or less. In a plan view of the first main surface 11 of the insulating substrate 10, the second heat transfer layer 41 May cover a region of the resistor 16 that is 200 μm or less from the end 16f of the resistor 16. The distance between the end 41e of the second heat transfer layer 41 and the end 16f of the resistor 16 in the first direction (x direction) may be 200 μm or less.

In a plan view of the first main surface 11 of the insulating substrate 10, the second heat transfer layer 41 covers, for example, 20% or more of the total area of the resistor 16. In a plan view of the first main surface 11 of the insulating substrate 10, the second heat transfer layer 41 May cover 25% or more of the total area of the resistor 16, 30% or more of the total area of the resistor 16, 35% or more of the total area of the resistor 16, or 40% or more of the total area of the resistor 16. In a plan view of the first main surface 11 of the insulating substrate 10, the second heat transfer layer 41 covers, for example, less than 50% of the total area of the resistor 16. In a plan view of the first main surface 11 of the insulating substrate 10, the second heat transfer layer 41 may be separated from the entire trimming groove 17. The entire trimming groove 17 may be exposed from the second heat transfer layer 41.

The second heat transfer layer 41 includes a binder resin and thermally conductive particles added to the binder resin. The binder resin is formed of an epoxy resin, a phenolic resin, or a combination thereof. The thermally conductive particles have a thermal conductivity greater than that of the binder resin. The thermally conductive particles are made of, for example, a material having a thermal conductivity of 5.0 W/(m·K) or more. The thermally conductive particles may be made of a material having a thermal conductivity of 10.0 W/(m·K) or more, or may be made of a material having a thermal conductivity of 20.0 W/(m·K) or more. The thermally conductive particles are, for example, metal particles such as silver particles or copper particles, carbon particles, or a combination thereof. The second heat transfer layer 41 is formed, for example, by printing a paste containing a binder resin and thermally conductive particles and curing the paste.

The second heat transfer layer 41 May be electrically conductive. Second electrical resistivity of the second heat transfer layer 41 is greater than the electrical resistivity of the resistor 16. The second electrical resistivity of the second heat transfer layer 41 is, for example, 1000 times or more than the electrical resistivity of the resistor 16. The second electrical resistivity of the second heat transfer layer 41 is greater than the electrical resistivity of the second front electrode 31. The second electrical resistivity of the second heat transfer layer 41 is, for example, 10000 times or more than the electrical resistivity of the second front electrode 31.

The insulating protective layer 43 is provided on the resistor 16. The insulating protective layer 43 electrically insulates the first electrode 20 and the second electrode 30 from each other. Specifically, the insulating protective layer 43 electrically insulates the first front electrode 21 and the second front electrode 31 from each other. The insulating protective layer 43 electrically insulates the first metal plating layer 24 and the second metal plating layer 34 from each other. The insulating protective layer 43 electrically insulates the first heat transfer layer 40 and the second heat transfer layer 41 from each other. The insulating protective layer 43 electrically insulates the first conductive resin layer 45 and the second conductive resin layer 46 from each other. The insulating protective layer 43 is made of, for example, an insulating resin such as an epoxy resin. The insulating protective layer 43 is formed, for example, by printing a paste containing an insulating resin and curing the paste.

The first conductive resin layer 45 is provided on the first heat transfer layer 40 and the insulating protective layer 43. The first conductive resin layer 45 is in contact with the first heat transfer layer 40 and the insulating protective layer 43. The first conductive resin layer 45 includes an end 45e that is a distal end of the first conductive resin layer 45 relative to the first side surface 13 of the insulating substrate 10 in a plan view of the first main surface 11 of the insulating substrate 10. The first conductive resin layer 45 has an electrical resistivity smaller than that of the first heat transfer layer 40. The first conductive resin layer 45 has a thermal conductivity greater than that of the insulating protective layer 43. The first conductive resin layer 45 May have a thermal conductivity greater than that of the first heat transfer layer 40. The first conductive resin layer 45 May have an electrical resistivity greater than that of the resistor 16. The first conductive resin layer 45 May have an electrical resistivity greater than that of the first front electrode 21.

The first conductive resin layer 45 includes a binder resin and conductive particles added to the binder resin. The binder resin is formed of an epoxy resin, a phenolic resin, or a combination thereof. The conductive particles have an electrical resistivity smaller than that of the binder resin. The conductive particles are metal particles such as silver particles or copper particles, for example. The first conductive resin layer 45 is formed, for example, by printing a paste containing a binder resin and conductive particles and curing the paste.

The second conductive resin layer 46 is provided on the second heat transfer layer 41 and the insulating protective layer 43. The second conductive resin layer 46 is in contact with the second heat transfer layer 41 and the insulating protective layer 43. The second conductive resin layer 46 is separated from the first conductive resin layer 45 in the first direction (x direction). The second conductive resin layer 46 includes an end 46e that is a distal end of the second conductive resin layer 46 relative to the second side surface 14 of the insulating substrate 10 in a plan view of the first main surface 11 of the insulating substrate 10. The second conductive resin layer 46 has an electrical resistivity smaller than that of the second heat transfer layer 41. The second conductive resin layer 46 has a thermal conductivity greater than that of the insulating protective layer 43. The second conductive resin layer 46 May have a thermal conductivity greater than that of the second heat transfer layer 41. The second conductive resin layer 46 May have an electrical resistivity greater than that of the resistor 16. The second conductive resin layer 46 May have an electrical resistivity greater than that of the second front electrode 31.

The second conductive resin layer 46 includes a binder resin and conductive particles added to the binder resin. The binder resin is formed of an epoxy resin, a phenolic resin, or a combination thereof. The conductive particles have an electrical resistivity smaller than that of the binder resin. The conductive particles are metal particles such as silver particles or copper particles, for example. The second conductive resin layer 46 is formed, for example, by printing a paste containing a binder resin and conductive particles and curing the paste.

In a plan view of the first main surface 11 of the insulating substrate 10, the end 45e of the first conductive resin layer 45 May be closer to the end 41e of the second heat transfer layer 41 than the end 40e of the first heat transfer layer 40. In a plan view of the first main surface 11 of the insulating substrate 10, the end 46e of the second conductive resin layer 46 May be closer to the end 40e of the first heat transfer layer 40 than the end 41e of the second heat transfer layer 41. In a plan view of the first main surface 11 of the insulating substrate 10, the end 24e of the first metal plating layer 24 May be closer to the end 41e of the second heat transfer layer 41 than the end 40e of the first heat transfer layer 40. In a plan view of the first main surface 11 of the insulating substrate 10, the end 34e of the second metal plating layer 34 May be closer to the end 40e of the first heat transfer layer 40 than the end 41e of the second heat transfer layer 41.

With reference to FIG. 3, the chip resistor 1 is mounted on the wiring substrate 50, for example. Specifically, the wiring substrate 50 includes an insulating substrate 51 and electrical wirings 52 and 53. The first electrode 20 of the chip resistor 1 is bonded to the electrical wiring 52 of the wiring substrate 50 using the conductive bonding member 54 such as solder. The second electrode 30 of the chip resistor 1 is bonded to the electrical wiring 53 of the wiring substrate 50 using the conductive bonding member 55 such as solder.

An example method of manufacturing the chip resistor 1 of the present embodiment will be described with reference to FIGS. 1, 2 and 4 to 9.

With reference to FIG. 4, the first front electrode 21 and the second front electrode 31 are formed on the first main surface 11 of the insulating substrate 10. For example, the first front electrode 21 and the second front electrode 31 are formed by printing a paste containing silver on the first main surface 11 of the insulating substrate 10 and firing the paste. The first back electrode 22 and the second back electrode 32 are formed on the second main surface 12 of the insulating substrate 10. For example, the first back electrode 22 and the second back electrode 32 are formed by printing a paste containing silver on the second main surface 12 of the insulating substrate 10 and firing the paste.

With reference to FIG. 5, the resistor 16 is formed on the first main surface 11 of the insulating substrate 10. The resistor 16 is formed by printing a paste which is obtained by adding fritted glass to an electrical resistance material such as ruthenium oxide (RuO₂) or a silver-palladium alloy and firing the paste. It is acceptable that the resistor 16 is formed on the first main surface 11 of the insulating substrate 10, and the first front electrode 21, the second front electrode 31, the first back electrode 22, and the second back electrode 32 are formed thereafter.

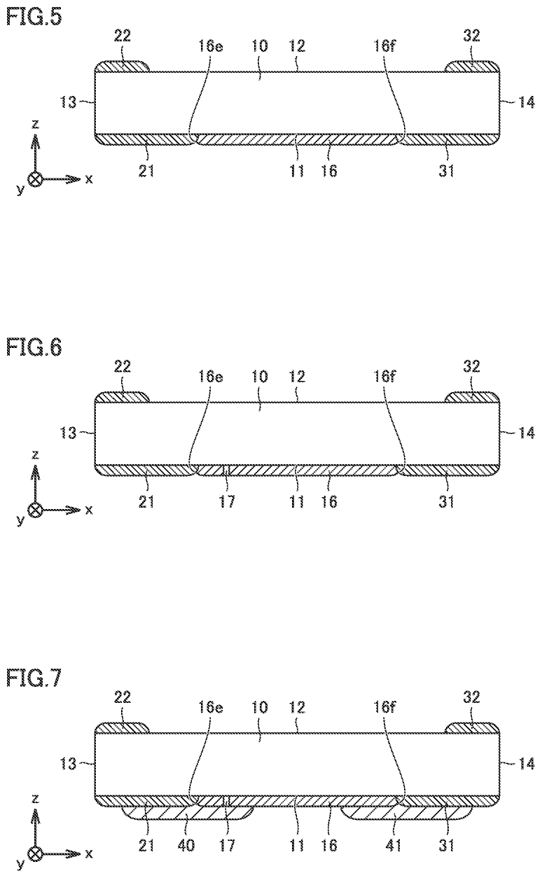

With reference to FIG. 6, the trimming groove 17 is formed on the resistor 16. The trimming groove 17 is formed, for example, by irradiating the resistor 16 with a laser beam. When the resistance value of the resistor 16 reaches a target resistance value of the chip resistor 1, the formation of the trimming groove 17 is terminated.

With reference to FIG. 7, the first heat transfer layer 40 and the second heat transfer layer 41 are formed. Specifically, the first heat transfer layer 40 is formed by printing a paste containing a binder resin and thermally conductive particles on the resistor 16 and the first front electrode 21 and curing the paste. The second heat transfer layer 41 is formed by printing a paste containing a binder resin and thermally conductive particles on the resistor 16 and the second front electrode 31 and curing the paste.

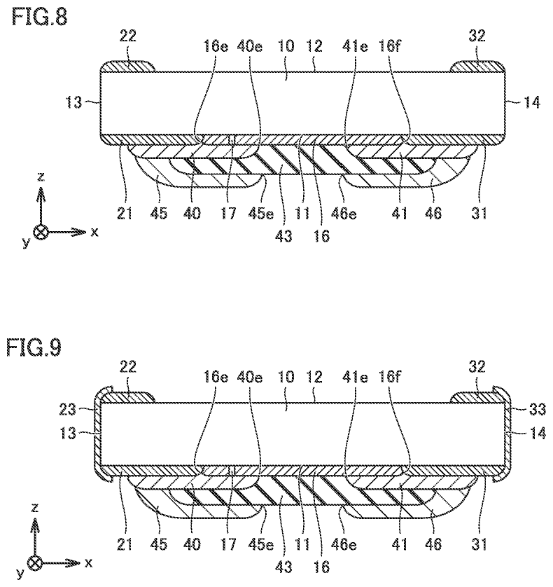

With reference to FIG. 8, the insulating protective layer 43 is formed on the resistor 16, the first heat transfer layer 40 and the second heat transfer layer 41.

Specifically, the insulating protective layer 43 is formed by printing a paste containing an insulating resin such as an epoxy resin on the resistor 16, the first heat transfer layer 40 and the second heat transfer layer 41 and curing the paste. Thereafter, the first conductive resin layer 45 and the second conductive resin layer 46 are formed. Specifically, the first conductive resin layer 45 is formed by printing a paste containing a binder resin and conductive particles on the insulating protective layer 43 and the first heat transfer layer 40 and curing the paste.. The second conductive resin layer 46 is formed by printing a paste containing a binder resin and conductive particles on the insulating protective layer 43 and the second heat transfer layer 41 and curing the paste.

With reference to FIG. 9, the first side electrode 23 and the second side electrode 33 are formed. Specifically, the first side electrode 23 is formed on the first side surface 13 of the insulating substrate 10, the first front electrode 21 and the first back electrode 22 by physical vapor deposition (PVD) such as sputtering. The first side electrode 23 is in contact with the first front electrode 21 and the first back electrode 22, and is electrically connected to the first front electrode 21 and the first back electrode 22. The second side electrode 33 is formed on the second side surface 14 of the insulating substrate 10, the second front electrode 31 and the second back electrode 32 by physical vapor deposition (PVD) such as sputtering. The second side electrode 33 is in contact with the second front electrode 31 and the second back electrode 32, and is electrically connected to the second front electrode 31 and the second back electrode 32.

With reference to FIGS. 1 and 2, the first metal plating layer 24 and the second metal plating layer 34 are formed. The first metal plating layer 24 includes, for example, a first inner plating layer 25, a first intermediate plating layer 26, and a first outer plating layer 27. The second metal plating layer 34 includes, for example, a second inner plating layer 35, a second intermediate plating layer 36, and a second outer plating layer 37.

Specifically, the first inner plating layer 25 is formed on the first front electrode 21, the first back electrode 22, the first side electrode 23, the first heat transfer layer 40 and the first conductive resin layer 45. The second inner plating layer 35 is formed on the second front electrode 31, the second back electrode 32, the second side electrode 33, the second heat transfer layer 41 and the second conductive resin layer 46. Each of the first inner plating layer 25 and the second inner plating layer 35 is, for example, a copper plating layer. Thereafter, the first intermediate plating layer 26 is formed on the first inner plating layer 25. The second intermediate plating layer 36 is formed on the second inner plating layer 35. Each of the first intermediate plating layer 26 and the second intermediate plating layer 36 is, for example, a nickel plating layer. Thereafter, the first outer plating layer 27 is formed on the first intermediate plating layer 26. The second outer plating layer 37 is formed on the second intermediate plating layer 36. Each of the first outer plating layer 27 and the second outer plating layer 37 is, for example, a tin plating layer. Thereby, the chip resistor 1 is obtained.

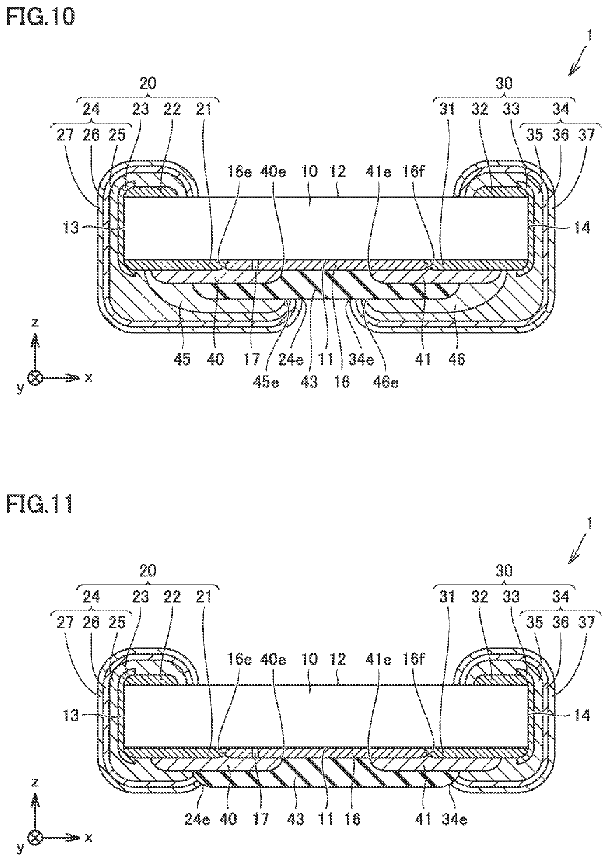

With reference to FIG. 10, in a first modification, a portion of the first heat transfer layer 40 exposed from the insulating protective layer 43 May be completely covered with the first conductive resin layer 45. The first conductive resin layer 45 may be in contact with the first front electrode 21. The first heat transfer layer 40 May be separated from the first metal plating layer 24 (the first inner plating layer 25). A portion of the second heat transfer layer 41 exposed from the insulating protective layer 43 May be completely covered with the second conductive resin layer 46. The second conductive resin layer 46 May be in contact with the second front electrode 31. The second heat transfer layer 41 May be separated from the second metal plating layer 34 (the second inner plating layer 35).

With reference to FIG. 11, in a second modification, the first conductive resin layer 45 and the second conductive resin layer 46 May not be provided. The first inner plating layer 25 May be formed on the first front electrode 21, the first heat transfer layer 40, the first side electrode 23 and the first back electrode 22. The second inner plating layer 35 May be formed on the second front electrode 31, the second heat transfer layer 41, the second side electrode 33, and the second back electrode 32.

In a third modification, the first back electrode 22, the first side electrode 23, the second back electrode 32, and the second side electrode 33 May not be provided. In the third modification, the first metal plating layer 24 is provided on the first front electrode 21 and the first heat transfer layer 40, and the second metal plating layer 34 is provided on the second front electrode 31 and the second heat transfer layer 41. In the third modification, the first metal plating layer 24 May be further provided on the first conductive resin layer 45. In the third modification, the second metal plating layer 34 may be further provided on the second conductive resin layer 46.

The effect of the chip resistor 1 according to the present embodiment will be described.

The chip resistor 1 according to the present embodiment includes an insulating substrate 10, a first electrode 20, a second electrode 30, a resistor 16, a first heat transfer layer 40, a second heat transfer layer 41, and an insulating protective layer 43. The insulating substrate 10 includes a first main surface 11, a first side surface 13, and a second side surface 14 opposite to the first side surface 13. The first side surface 13 and the second side surface 14 are connected to the first main surface 11, respectively. The resistor 16 is provided on the first main surface 11 of the insulating substrate 10.

The first electrode 20 is provided on a side of the first side surface 13 of the insulating substrate 10. The first electrode 20 includes a first front electrode 21 provided on the first main surface 11 of the insulating substrate 10. The second electrode 30 is provided on a side of the second side surface 14 of the insulating substrate 10, and is separated from the first electrode 20. The second electrode 30 includes a second front electrode 31 provided on the first main surface 11 of the insulating substrate 10 and separated from the first front electrode 21. The resistor 16 is in contact with the first front electrode 21 and the second front electrode 31. The first heat transfer layer 40 has a thermal conductivity greater than that of the insulating protective layer 43, and is in contact with the resistor 16 and the first front electrode 21. The second heat transfer layer 41 is separated from the first heat transfer layer 40. The second heat transfer layer 41 has a thermal conductivity greater than that of the insulating protective layer 43, and is in contact with the resistor 16 and the second front electrode 31. The insulating protective layer 43 is provided on the resistor 16. The insulating protective layer 43 electrically insulates the first electrode 20 and the second electrode 30 from each other, and electrically insulates the first heat transfer layer 40 and the second heat transfer layer 41 from each other.

A central portion of the chip resistor 1 (for example, a central portion of the resistor 16) is furthest away from the first electrode 20 and the second electrode 30.

Therefore, the temperature in the central portion of the chip resistor 1 tends to rise during the use of the chip resistor 1. However, the first heat transfer layer 40 and the second heat transfer layer 41 can quickly dissipate heat in the central portion of the chip resistor 1 to the outside of the chip resistor 1 (for example, the wiring substrate 50 (see

FIG. 3) or an ambient environment of the chip resistor 1 such as air surrounding the chip resistor 1). Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, each of the first heat transfer layer 40 and the second heat transfer layer 41 includes a binder resin and thermally conductive particles added to the binder resin.

The first heat transfer layer 40 and the second heat transfer layer 41 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, the binder resin is formed of an epoxy resin, a phenol resin, or a combination thereof. The thermally conductive particles are carbon particles, metal particles, or a combination thereof.

The first heat transfer layer 40 and the second heat transfer layer 41 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, the first heat transfer layer 40 and the second heat transfer layer 41 are each electrically conductive.

Therefore, the first heat transfer layer 40 and the second heat transfer layer 41 which are electrically conductive tend to have a thermal conductivity greater than that of the heat transfer layer which is electrically insulating. The first heat transfer layer 40 and the second heat transfer layer 41 which are electrically conductive can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

The chip resistor 1 according to the present embodiment further includes a first conductive resin layer 45 and a second conductive resin layer 46. The first conductive resin layer 45 has a thermal conductivity greater than that of the insulating protective layer 43. The second conductive resin layer 46 has a thermal conductivity greater than that of the insulating protective layer 43, and is separated from the first conductive resin layer 45. The first electrode 20 further includes a first metal plating layer 24. The second electrode 30 further includes a second metal plating layer 34. The first conductive resin layer 45 is provided on the first heat transfer layer 40 and the insulating protective layer 43. The first metal plating layer 24 is provided on the first heat transfer layer 40 and the first conductive resin layer 45. The second conductive resin layer 46 is provided on the second heat transfer layer 41 and the insulating protective layer 43. The second metal plating layer 34 is provided on the second heat transfer layer 41 and the second conductive resin layer 46. In a plan view of the first main surface 11 of the insulating substrate 10, the first end (the end 24e) of the first metal plating layer 24 is closer to the third end (the end 41e) of the second heat transfer layer 41 than the second end (the end 40e) of the first heat transfer layer 40, and the fourth end (the end 34e) of the second metal plating layer 34 is closer to the second end (the end 40e) of the first heat transfer layer 40 than the third end (the end 41e) of the second heat transfer layer 41. The first end (the end 24e) of the first metal plating layer 24 is a distal end of the first metal plating layer 24 relative to the first side surface 13 of the insulating substrate 10 in a plan view of the first main surface 11. The second end (the end 40e) of the first heat transfer layer 40 is a distal end of the first heat transfer layer 40 relative to the first side surface 13 of the insulating substrate 10 in a plan view of the first main surface 11. The third end (the end 41e) of the second heat transfer layer 41 is a distal end of the second heat transfer layer 41 relative to the second side surface 14 of the insulating substrate 10 in a plan view of the first main surface 11. The fourth end (the end 34e) of the second metal plating layer 34 is a distal end of the second metal plating layer 34 relative to the second side surface 14 of the insulating substrate 10 in a plan view of the first main surface 11.

Therefore, in a plan view of the first main surface 11 of the insulating substrate 10, the first metal plating layer 24 is formed closer to the central portion of the chip resistor 1 than the first heat transfer layer 40, and the second metal plating layer 34 is formed closer to the center of the chip resistor 1 than the second heat transfer layer 41.

The first metal plating layer 24 and the second metal plating layer 34 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, in a plan view of the first main surface 11 of the insulating substrate 10, the fifth end (the end 45e) of the first conductive resin layer 45 is closer to the third end (the end 41e) of the second heat transfer layer 41 than the second end (the end 40e) of the first heat transfer layer 40, and the sixth end (the end 46e) of the second conductive resin layer 46 is closer to the second end (the end 40e) of the first heat transfer layer 40 than the third end (the end 41e) of the second heat transfer layer 41. The fifth end (the end 45e) of the first conductive resin layer 45 is a distal end of the first conductive resin layer 45 relative to the first side surface 13 of the insulating substrate 10 in a plan view of the first main surface 11. The sixth end (the end 46e) of the second conductive resin layer 46 is a distal end of the second conductive resin layer 46 relative to the second side surface 14 of the insulating substrate 10 in a plan view of the first main surface 11.

Therefore, in a plan view of the first main surface 11 of the insulating substrate 10, the first conductive resin layer 45 is formed closer to the central portion of the chip resistor 1 than the first heat transfer layer 40, and the second conductive resin layer 46 is formed closer to the center of the chip resistor 1 than the second heat transfer layer 41. The first conductive resin layer 45 and the second conductive resin layer 46 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, the insulating substrate 10 includes a second main surface 12 opposite to the first main surface 11.

The first electrode 20 includes a first back electrode 22 provided on the second main surface 12 of the insulating substrate 10. The second electrode 30 includes a second back electrode 32 provided on the second main surface 12 of the insulating substrate 10. The first metal plating layer 24 is in contact with the first front electrode 21 and the first back electrode 22. The second metal plating layer 34 is in contact with the second front electrode 31 and the second back electrode 32.

Therefore, the first back electrode 22 and the second back electrode 32 can quickly dissipate the heat of the chip resistor 1 to the outside of the chip resistor 1.

Therefore, it is possible to prevent the temperature in a central portion of the chip resistor 1 from rising during the use of the chip resistor 1, which makes it possible to improve the short overload (STOL) characteristics of the chip resistor 1.

In the chip resistor 1 according to the present embodiment, the first metal plating layer 24 includes a first copper plating layer (the first inner plating layer 25) in contact with the first front electrode 21. The second metal plating layer 34 includes a second copper plating layer (the second inner plating layer 35) in contact with the second front electrode 31.

The copper has a thermal conductivity of 398 W/(m·K), and the copper plating layer has a very high thermal conductivity. Therefore, the first metal plating layer 24 and the second metal plating layer 34 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, the first electrical resistivity of the first heat transfer layer 40 is 1000 times or more than the electrical resistivity of the resistor 16. The second electrical resistivity of the second heat transfer layer 41 is 1000 times or more than the electrical resistivity of the resistor 16.

Therefore, even if the first heat transfer layer 40 and the second heat transfer layer 41 are in contact with the resistor 16, the variation in the resistance value of the chip resistor 1 due to the first heat transfer layer 40 and the second heat transfer layer 41 can be ignored, which makes it possible to accurately determine the resistance value of the chip resistor 1 (the resistor 16).

In the chip resistor 1 according to the present embodiment, in a plan view of the first main surface 11 of the insulating substrate 10, the first heat transfer layer 40 covers 20% or more of the total area of the resistor 16, and the second heat transfer layer 41 covers 20% or more of the total area of the resistor 16.

Therefore, the first heat transfer layer 40 and the second heat transfer layer 41 can quickly dissipate heat in the central portion of the chip resistor 1 to the outside of the chip resistor 1. Therefore, it is possible to prevent the temperature in the central portion of the chip resistor 1 from rising during the use of the chip resistor 1, which makes it possible to improve the short overload (STOL) characteristics of the chip resistor 1.

In the chip resistor 1 according to the present embodiment, the resistor 16 is provided with a trimming groove 17. In a plan view of the first main surface 11 of the insulating substrate 10, the first heat transfer layer 40 covers at least a part of the trimming groove 17.

It is possible to accurately determine the resistance value of the chip resistor 1 (the resistor 16) by forming a trimming groove 17 on the resistor 16. When a current flows through the chip resistor 1, the temperature of a portion of the resistor 16 around the trimming groove 17 becomes highest in the resistor 16. In the chip resistor 1, the first heat transfer layer 40 covers at least a part of the trimming groove 17. Therefore, the heat generated in the portion of the resistor 16 around the trimming groove 17 can be dissipated quickly to the outside of the chip resistor 1.

In the chip resistor 1 of the present embodiment, the first heat transfer layer 40 covers 50% or more of the entire length of the trimming groove 17 in a plan view of the first main surface 11 of the insulating substrate 10.

Therefore, the heat generated in the portion of the resistor 16 around the trimming groove 17 can be dissipated more quickly to the outside of the chip resistor 1.

In the chip resistor 1 according to the present embodiment, in a plan view of the first main surface 11 of the insulating substrate 10, the first heat transfer layer 40 covers the entire trimming groove 17.

Therefore, the heat generated in the portion of the resistor 16 around the trimming groove 17 can be dissipated more quickly to the outside of the chip resistor 1.

It should be understood that the embodiments and modifications thereof disclosed herein are illustrative and not restrictive in all respects. The scope of the present disclosure is defined not by the above description but by the claims, and is intended to include all changes within the meaning and scope equivalent to the claims.

### REFERENCE SIGNS LIST

1: chip resistor; 10: insulating substrate; 11: first main surface; 12: second main surface; 13: first side surface; 14: second side surface; 16: resistor; 16e, 16f: end; 17: trimming groove; 20: first electrode; 21: first front electrode; 22: first back electrode; 23: first side electrode; 24: first metal plating layer; 24e: end; 25: first inner plating layer; 26: first intermediate plating layer; 27: first outer plating layer; 30: second electrode; 31: second front electrode; 32: second back electrode; 33: second side electrode; 34: second metal plating layer; 34e: end; 35: second inner plating layer; 36: second intermediate plating layer; 37: second outer plating layer; 40: first heat transfer layer; 40e: end; 41: second heat transfer layer; 41e: end; 43: insulating protective layer; 45: first conductive resin layer; 45e: end; 46: second conductive resin layer; 46e: end; 50: wiring substrate; 51: insulating substrate; 52, 53: electrical wiring; 54, 55: conductive bonding member

1. A chip resistor comprising:
an insulating substrate including a first main surface, a first side surface, and a second side surface opposite to the first side surface;
a first electrode provided on a side of the first side surface of the insulating substrate;
a second electrode provided on a side of the second side surface of the insulating substrate and separated from the first electrode;
a resistor provided on the first main surface;
a first heat transfer layer;
a second heat transfer layer separated from the first heat transfer layer; and
an insulating protective layer provided on the resistor,
the first side surface and the second side surface are each connected to the first main surface,
the first electrode includes a first front electrode provided on the first main surface,
the second electrode includes a second front electrode provided on the first main surface and separated from the first front electrode,
the resistor is in contact with the first front electrode and the second front electrode,
the first heat transfer layer has a thermal conductivity greater than that of the insulating protective layer, and is in contact with the resistor and the first front electrode,
the second heat transfer layer has a thermal conductivity greater than that of the insulating protective layer, and is in contact with the resistor and the second front electrode, and
the insulating protective layer electrically insulates the first electrode and the second electrode from each other, and electrically insulates the first heat transfer layer and the second heat transfer layer from each other.

2. The chip resistor according to claim 1, wherein
the first heat transfer layer and the second heat transfer layer each include a binder resin and thermally conductive particles added to the binder resin.

3. The chip resistor according to claim 2, wherein
the binder resin is formed of an epoxy resin, a phenolic resin, or a combination thereof, and
the thermally conductive particles are carbon particles, metal particles, or a combination thereof.

4. The chip resistor according to claim 1, wherein
the first heat transfer layer and the second heat transfer layer are each electrically conductive.

5. The chip resistor according to claim 4, further comprising:
a first conductive resin layer having a thermal conductivity greater than that of the insulating protective layer; and
a second conductive resin layer having a thermal conductivity greater than that of the insulating protective layer and separated from the first conductive resin layer, wherein
the first electrode further includes a first metal plating layer,
the second electrode further includes a second metal plating layer,
the first conductive resin layer is provided on the first heat transfer layer and the insulating protective layer,
the first metal plating layer is provided on the first heat transfer layer and the first conductive resin layer,
the second conductive resin layer is provided on the second heat transfer layer and the insulating protective layer,
the second metal plating layer is provided on the second heat transfer layer and the second conductive resin layer,
in a plan view of the first main surface, a first end of the first metal plating layer is closer to a third end of the second heat transfer layer than a second end of the first heat transfer layer, and a fourth end of the second metal plating layer is closer to the second end of the first heat transfer layer than the third end of the second heat transfer layer,
in the plan view of the first main surface, the first end of the first metal plating layer is a distal end of the first metal plating layer relative to the first side surface,
in the plan view of the first main surface, the second end of the first heat transfer layer is a distal end of the first heat transfer layer relative to the first side surface,
in the plan view of the first main surface, the third end of the second heat transfer layer is a distal end of the second heat transfer layer relative to the second side surface, and
in the plan view of the first main surface, the fourth end of the second metal plating layer is a distal end of the second metal plating layer relative to the second side surface.

6. The chip resistor according to claim 5, wherein
in the plan view of the first main surface, a fifth end of the first conductive resin layer is closer to the third end of the second heat transfer layer than the second end of the first heat transfer layer, and a sixth end of the second conductive resin layer is closer to the second end of the first heat transfer layer than the third end of the second heat transfer layer,
in the plan view of the first main surface, the fifth end of the first conductive resin layer is a distal end of the first conductive resin layer relative to the first side surface, and
in the plan view of the first main surface, the sixth end of the second conductive resin layer is a distal end of the second conductive resin layer relative to the second side surface.

7. The chip resistor according to claim 5, wherein
the insulating substrate includes a second main surface opposite to the first main surface,
the first electrode includes a first back electrode provided on the second main surface,
the second electrode includes a second back electrode provided on the second main surface,
the first metal plating layer is in contact with the first front electrode and the first back electrode, and
the second metal plating layer is in contact with the second front electrode and the second back electrode.

8. The chip resistor according to claim 5, wherein
the first metal plating layer includes a first copper plating layer in contact with the first front electrode, and
the second metal plating layer includes a second copper plating layer in contact with the second front electrode.

9. The chip resistor according to claim 1, wherein
first electrical resistivity of the first heat transfer layer is 1000 times or more than electrical resistivity of the resistor, and
second electrical resistivity of the second heat transfer layer is 1000 times or more than the electrical resistivity of the resistor.

10. The chip resistor according to claim 1, wherein in the plan view of the first main surface, the first heat transfer layer covers 20% or more of an area of the resistor, and the second heat transfer layer covers 20% or more of the area of the resistor.

11. The chip resistor according to claim 1, wherein
the resistor is provided with a trimming groove,
in the plan view of the first main surface, the first heat transfer layer covers at least a part of the trimming groove.

12. The chip resistor according to claim 11, wherein
in the plan view of the first main surface, the first heat transfer layer covers 50% or more of the total length of the trimming groove.

13. The chip resistor according to claim 11, wherein
in the plan view of the first main surface, the first heat transfer layer covers the entire trimming groove.
